(19) United States
(12) Patent Application Publication
(10) Pub. No.: US 2015/0251497 A1
(43) Pub. Date: Sep. 10, 2015

(54) Tire For Heavy Civil Engineering Vehicle

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: OLivier Ferlin, Clermont-Ferrand Cedex 9 (FR)

(21) Appl. No.: 14/431,602

(22) PCT Filed: Sep. 24, 2013
(86) PCT No.: PCT/EP2013/069784

§ 371 Date: Mar. 26, 2015

(30) Foreign Application Priority Data
Sep. 26, 2012 (FR) 1259026

(51) Int. Cl. B60C 9/20; B60C 9/00

(52) U.S. Cl. CPC B60C 9/2003; B60C 9/0007; B60C 2009/0078; B60C 2009/0085; B60C 2009/2051; B60C 2009/208; B60C 2009/209

(57) ABSTRACT

Radial tire which is less sensitive to knocks that occur at the middle of the tread. The tire comprises, radially from the outside inwards, a tread (2), a crown reinforcement (3) and a carcass reinforcement (4). The crown reinforcement (3) comprises, radially from the outside inwards, a protective reinforcement (5), a working reinforcement (6), and an additional reinforcement (7) centred on the equatorial plane of the tire, comprising at least one additional layer (71, 72) formed of metallic reinforcers making with the circumferential direction an angle of at most 10°, the metallic reinforcers of each additional layer (71, 72) being elastic and having a tensile elastic modulus at most equal to 150 GPa.

The present invention relates to a radial tire intended to be fitted to a heavy vehicle of the civil engineering type and, more particularly, to the crown of such a tire.

Although not limited to this type of application, the invention is more particularly described with reference to a large-sized radial tire intended for example to be fitted to a dumper, a vehicle that transports materials taken from quarries or open-cast mines. The nominal diameter of the rim of such a tire, within the meaning of the European Tire and Rim Technical Organisation or ETRTO standard, is at least 25 inches.

A tire comprises two beads which provide the mechanical connection between the tire and the rim on which it is mounted, the beads being joined respectively by two sidewalls to a tread intended to come into contact with the ground via a tread surface.

Because a tire has a geometry exhibiting symmetry of revolution with respect to an axis of rotation, the geometry of the tire is generally described in a meridian plane containing the axis of rotation of the tire. For a given meridian plane, the radial, axial and circumferential directions respectively mean directions perpendicular to the axis of rotation of the tire, parallel to the axis of rotation of the tire and perpendicular to the meridian plane.

In what follows, the expressions “radially on the inside or respectively radially on the outside of” mean “respectively closer to or further away from the axis of rotation of the tire”. The expression “axially on the inside or respectively axially on the outside of” means “closer to, or respectively further away from, the equatorial plane of the tire”, the equatorial plane of the tire being the plane passing through the middle of the tread surface of the tire and perpendicular to the axis of rotation of the tire.

A radial tire comprises a reinforcement made up of a crown reinforcement, radially on the inside of the tread, and of a carcass reinforcement, radially on the inside of the crown reinforcement.

The carcass reinforcement of a radial tire for a heavy vehicle of the civil engineering type usually comprises at least one carcass layer consisting of generally metallic reinforcers coated in a polymer material referred to as the coating compound. The carcass layer comprises a main part connecting the two beads together and turned up, within each bead, from the inside towards the outside of the tire, around a generally metallic circumferential reinforcing element referred to as a bead wire, to form a turn-up. The metallic reinforcers of a carcass layer are substantially parallel to one another and make with the circumferential direction an angle of between 85° and 95°.

The crown reinforcement of a radial tire for a heavy vehicle of the civil engineering type comprises a superposition of crown layers arranged circumferentially, radially on the outside of the carcass reinforcement. Each crown layer is made up of generally metallic reinforcers which are parallel to one another and coated in a polymer material or coating compound.

Among the crown layers, a distinction is usually made between the protective layers, that make up the protective reinforcement and are radially furthest towards the outside, and the working layers, that make up the working reinforcement and are located radially between the protective reinforcement and the carcass reinforcement.

The protective reinforcement, made up of at least one protective layer, essentially protects the working layers from mechanical or physico-chemical attack likely to spread through the thread radially towards the inside of the tire.

The protective reinforcement often comprises two protective layers, radially superposed, formed of elastic metallic reinforcers parallel to one another within each layer and crossed from one layer to the next, making with the circumferential direction angles of which the absolute value is generally between 10° and 35°, and preferably between 15° and 30°.

The working reinforcement, made up of at least two working layers, has the function of belting the tire and of providing the tire with rigidity and roadholding. It reacts both mechanical stresses of inflation, which are generated by the tire inflation pressure and transmitted by the carcass reinforcement, and mechanical stresses of running, which are generated by the running of the tire over the ground and transmitted by the tread. It has also to withstand oxidation, knocks and perforations, by virtue of its intrinsic design and that of the protective reinforcement.

The working reinforcement usually comprises two working layers, radially superposed, formed of inelastic metallic reinforcers, parallel to one another within each layer and crossed from one layer to the next, making with the circumferential direction angles of which the absolute value is generally at most equal to 60° and preferably between 15° and 40°.

A metallic reinforcer is mechanically characterized by a curve representing the tensile force (in N) applied to the metallic reinforcer as a function of the relative elongation (in %) of the metallic reinforcer, referred to as the force-elongation curve. Tensile mechanical properties such as the structural elongation Aₛ (in %), the total elongation at break Aₜ (in %), the force at break Fₘ (maximum load in N) and the breaking strength Rₘ (in MPa) are deduced from this force-elongation curve, these properties being measured in accordance with 1984 ISO Standard 6892.

The total elongation at break Aₜ of the metallic reinforcer is, by definition, the sum of the structural, elastic and plastic elongations (Aₜ=Aₛ+Aₑ+Aₚ). The structural elongation Aₛ is the result of the relative positioning of the metallic threads that make up the metallic reinforcer under light tensile load. The elastic elongation Aₑ is the result of the actual elasticity of the metal of the metallic threads that make up the metallic reinforcer, considered individually (Hooke's law). The plastic elongation Aₚ is the result of the plasticity (irreversible deformation beyond the elastic limit) of the metal of these metallic threads considered individually. These various elongations and their respective significance, well known to those skilled in the art, are described for example in documents U.S. Pat. No. 5,843,583, WO2005/014925 and WO2007/090603.

A tensile modulus (in GPa) is also defined at every point on the force-elongation curve and represents the gradient of the straight line tangential to the force-elongation curve at that point. In particular, the tensile elastic modulus or Young's modulus is the name given to the tensile modulus of the elastic linear part of the force-elongation curve.

With metallic reinforcers, a distinction is usually made between elastic metallic reinforcers, such as those used in the protective layers, and inelastic metallic reinforcers, such as those used in the working layers.

An elastic metallic reinforcer is characterized by a structural elongation Aₛ at least equal to 1% and a total elongation at break Aₜ at least equal to 4%. Furthermore, an elastic metallic reinforcer has a tensile elastic modulus at most equal to 150 GPa, and generally of between 40 GPa and 150 GPa.

An inelastic metallic reinforcer is characterized by a relative elongation, under a tensile force equal to 10% of the breaking force Fₘ, at most equal to 0.2%. Moreover, an inelastic metallic reinforcer has a tensile elastic modulus usually of between 150 GPa and 200 GPa.

An elastic metallic reinforcer or elastic cord is usually a multistrand rope, namely formed of an assembly of several strands of which the structure is, for example, of the type K*(L+M) in the frequent case in which the strands are two-layered strands. K is the number of two-layered strands, L is the number of metallic threads making up the internal layer of a strand and M is the number of metallic threads making up the external layer of a strand. A two-layered strand is usually obtained by the helical winding of M strands constituting an external layer of a strand around L wires constituting an internal layer of the strand.

For an elastic cord of the multistrand rope type, the structural elongation Aₛ is the result of the actual construction and aeration of the multistrand rope and/or of its elementary strands and the inherent elasticity thereof, and possibly of a preformation imposed on one or more of these constituent strands and/or threads. The aeration of the cord is the result, firstly, of the separation of the threads with respect to the axial direction (direction perpendicular to the direction of the axis of the strand) and secondly of the separation of the strands with respect to the axial direction (direction perpendicular to the direction of the axis of the cord).

In order to reduce the mechanical inflation stresses transmitted to the working reinforcement, it is known from documents FR 2 419 181 and FR 2 419 182 to arrange an additional reinforcement, referred to as a limiting block, between the working reinforcement and the carcass reinforcement, its function being partially to react the mechanical inflation stresses.

Document FR 2 419 181 describes and claims a crown reinforcement comprising a working reinforcement made up of at least two working layers the metallic reinforcers of which make with the circumferential direction angles at least equal to +/−30°, and an additional reinforcement or limiting block, comprising at least two additional layers the metallic reinforcers of which cannot be extended very much, i.e. are inelastic, and make with the circumferential direction angles that are the opposite from one layer to the next, at most equal to one quarter of the smallest angle of the working layers. This limiting block is centred on the equatorial plane and has a width at most equal to the region of parallelism between the crown reinforcement and the carcass reinforcement.

Document FR 2 419 182 describes and claims a crown reinforcement comprising a working reinforcement made up of at least two working layers the metallic reinforcers of which make with the circumferential direction angles at least equal to +/−30°, and an additional reinforcement or limiting block, comprising at least two additional layers the metallic reinforcers of which cannot be extended very much, i.e. are inelastic, and make with the circumferential direction angles that are the opposite from one layer to the next, at most equal to half the smallest angle of the working layers and, for preference, of between 5° and 10°. This limiting block is centred on the equatorial plane and has a width at most equal to the region of parallelism between the crown reinforcement and the carcass reinforcement.

However, an additional reinforcement made up of two layers the metallic reinforcers of which are inelastic and make with the circumferential direction angles preferably of between 5° and 10° and crossed from one layer to the next, leads to excessive stiffening of the crown reinforcement. This stiffening of the crown reinforcement leads to increased sensitivity of the tire to the knocks suffered at the centre of the tread because a large proportion of the energy of deformation generated by the knocks is then transmitted to the carcass reinforcement, the life of which is therefore reduced.

The inventors have set themselves the objective of making the crown of a radial tire for a heavy vehicle of the civil engineering type less sensitive to the knocks that occur essentially at the middle of the tread.

This objective has been achieved, according to the invention, by a tire for a heavy vehicle of the civil engineering type, comprising:
a tread, a crown reinforcement radially on the inside of the tread and a carcass reinforcement radially on the inside of the crown reinforcement,
the crown reinforcement comprising, radially from the outside inwards,
a protective reinforcement comprising at least one protective layer formed of elastic metallic reinforcers making with the circumferential direction an angle at least equal to 10°,
a working reinforcement comprising at least two working layers formed of inelastic metallic reinforcers which are crossed from one working layer to the next and make with the circumferential direction an angle of at most 60°,
an additional reinforcement centred on the equatorial plane of the tire, comprising at least one additional layer formed of metallic reinforcers making with the circumferential direction an angle of at most 10°,
the metallic reinforcers of each additional layer being elastic and having a tensile elastic modulus at most equal to 150 GPa.

In the prior art cited hereinabove, the tensile stiffness of the additional reinforcement is appreciably greater than the tensile rigidity of the working reinforcement, in the middle portion of the crown, in the vicinity of the equatorial plane of the tire. The tensile rigidity of a reinforcement means the tensile force that needs to be exerted per unit width of reinforcement in order to obtain a 1 mm elongation of the said reinforcement: it is dependent on the tensile modulus of the metallic reinforcers and on the angles formed by the said metallic reinforcers with the circumferential direction. By way of example and nonlimitingly, in the prior art, the tensile rigidity of the additional reinforcement is approximately equal to twice the tensile rigidity of the working reinforcement, in the central portion of the crown.

Taking into consideration the respective tensile rigidities of the additional reinforcement and of the working reinforcement, a large proportion of the load is reacted by the additional reinforcement. When the tensile rigidity of the additional reinforcement is estimated at about twice the tensile rigidity of the working reinforcement, two-thirds of the tire inflation load are reacted by the additional reinforcement whereas one-third of the tire inflation load is reacted by the working reinforcement.

As the tire is compressed during use, the working reinforcement is therefore able to go into compression, in its central portion, with a risk of the metallic reinforcers of the working layers breaking in buckling. In addition, because the additional reinforcement therefore reacts high tensile load, the metallic reinforcers of the additional layers carry the risk of breaking under tension. This phenomenon is all the more pronounced because a civil engineering tire usually runs on ground comprising numerous obstacles such as rocks, and is therefore subject to repeated knocks leading to the appearance of high localized tensile and compressive loads. Placing the working reinforcement under compression and the additional reinforcement under tension is damaging to the endurance of the crown reinforcement.

The additional reinforcement of the invention makes it possible to rebalance the reaction of load between the working reinforcement and the additional reinforcement. Specifically, in this case, because the tensile modulus of the elastic metallic reinforcers that make up the additional layers of the additional reinforcement is limited to 150 GPa, for given angles with the circumferential direction, the tensile rigidity of the additional reinforcement is therefore limited and becomes substantially equal to the tensile rigidity of the working reinforcement. This means that the two reinforcements will react substantially the same level of load. In compression, by comparison with the prior art, the tensile load reacted by the additional reinforcement will decrease whereas the compressive load reacted by the working reinforcement in the central portion thereof will decrease or even cancel out. This results in a significant reduction in the risk of breakage of the metallic reinforcers of the working layers in buckling and of breakage of the metallic reinforcers of the working layers in tension, hence giving an overall improvement in crown reinforcement endurance.

Usually, the elastic metallic reinforcers of each additional layer have a tensile elastic modulus of between 40 GPa and 150 GPa.

Advantageously, the elastic metallic reinforcers of each additional layer are multistrand ropes formed of an assembly of strands made up of individual threads. This type of reinforcer has the advantage of being manufactured using methods that are known and well mastered.

According to one preferred embodiment, the elastic metallic reinforcers of each additional layer are multistrand ropes formed of an assembly of strands having two concentric layers of threads, and of structure K * (L+M), where K is the number of strands, L is the number of threads in the internal layer of a strand and M is the number of threads in the external layer of a strand. This type of reinforcer is characterized by good penetrability of a coating compound, guaranteeing good resistance to corrosion and therefore improved endurance of the crown reinforcement.

According to a first alternative form of the preferred embodiment, the elastic metallic reinforcers of each additional layer are cords of formula E 3*(1+6).28, formed of 3 strands, each strand being formed of an internal thread and of an external layer of 6 threads, each thread having a diameter of 0.28 mm.

According to a second alternative form of the preferred embodiment, the elastic metallic reinforcers of each additional layer are cords of formula E 4*(4+9).26, formed of 4 strands, each strand being formed of an internal layer of 4 threads and of an external layer of 9 threads, each thread having a diameter of 0.26 mm.

According to another alternative form of the preferred embodiment, the elastic metallic reinforcers of each additional layer are cords of formula E 4*(1+5).26, formed of 4 strands, each strand being formed of an internal thread and of an external layer of 5 threads, each thread having a diameter of 0.26 mm.

Advantageously, the axial width of the additional reinforcement is at most equal to 0.4 times the nominal section width of the tire. The axial width of the additional reinforcement is the axial width of the widest additional layer, measured between the two axial ends thereof. However, the additional layers may have the same axial width, which is then the axial width of the additional reinforcement. The nominal section width of the tire, within the meaning of the European Tire and Rim Technical Organisation (ETRTO) standard, is the width of the tire mounted and inflated on its theoretical rim and indicated in the size of the tire.

The additional reinforcement advantageously comprises at least two additional layers. Taking into consideration the tensile rigidity desired for the additional reinforcement, namely substantially the same level as that of the middle portion of the working reinforcement, and taking into consideration the type of metallic cords used, of the multistrand rope type of structure K*(L+M), the additional reinforcement a priori comprises at least two additional layers, or even three additional layers which are superposed.

According to a first preferred embodiment, the elastic metallic reinforcers of each additional layer make with the circumferential direction an angle of between 5° and 10°. More specifically, the absolute value of the angle is between 5° and 10°. The sign of the angle is defined with respect to the orthonormal frame of reference (X, Y, Z), where X is the axis in the circumferential direction oriented in the direction of rotation of the tire and Z is the axis in the radial direction oriented towards the outside of the tire. For preference, the metallic reinforcers are crossed from one additional layer to the next, making with the circumferential direction angles which are equal in terms of absolute value but of opposite sign.

An angle with an absolute value of between 5° and 10° guarantees the desired hooping effect and the expected reaction of circumferential tensile load. An angle with an absolute value substantially equal to 8° guarantees the additional reinforcement satisfactory effectiveness.

From a manufacturing standpoint, additional layers at non-zero angles are also easier to implement using known tire building methods.

According to a second preferred embodiment, the elastic metallic reinforcers of each additional layer make with the circumferential direction a zero angle.

An additional reinforcement made up of additional layers the elastic metallic reinforcers of which make with the circumferential direction a zero angle, namely which are oriented circumferentially, makes it possible to maximize the contribution made by the additional reinforcement to the reaction of circumferential load.

Furthermore, the additional reinforcement is made less sensitive to the risk of separation at the axial ends of its constituent additional layers. This is because when the additional layers have a non-zero angle, there is a risk of the additional layers separating as a result of the presence of the ends of the metallic reinforcers at the axial ends of the additional layers. For additional layers at a zero angle, there are no longer any ends of metallic reinforcers likely to cause the layers to separate.

In manufacture, an additional reinforcement at a zero angle makes it possible to reduce the number of connections or welds, within one and the same additional layer, when laying it in the circumferential direction, hence gaining in terms of productivity and reducing the risk of openings at the welds.

An additional reinforcement at a zero angle can be manufactured using various alternative forms of the method of manufacture.

According to a first alternative form of the method of manufacturing an additional reinforcement at a zero angle, each additional layer is formed by the circumferential winding of a single strip made up of elastic metallic reinforcers, radially on the outside of the carcass reinforcement. This method allows the additional reinforcement to be laid in a single hit, with just one final weld, and thus guarantees good productivity.

According to a second alternative form of the method of manufacturing an additional reinforcement at a zero angle, each additional layer is formed by the circumferential winding of an axial juxtaposition of strips made up of elastic metallic reinforcers, radially on the outside of the carcass reinforcement. This method enables the use of elementary strips of standard width, allowing flexibility in the choice of axial width of a given additional layer and, for example, allows the axial widths of the additional layers to change within one and the same additional reinforcement. The use of elementary strips may possibly allow the juxtaposition of different material components: types of elastic cord, types of coating compound. In other words, this alternative form of manufacture with the juxtaposition of elementary strips permits flexibility in terms of the axial widths and of the material components of the additional layers.

Finally, according to a third alternative form of the method of manufacturing an additional reinforcement at a zero angle, each additional layer is formed by the circumferential winding of an individual elastic metallic reinforcer, radially on the outside of the carcass reinforcement. This method is both productive and allows flexibility in terms of the axial widths and of the material components of the additional layers.

For preference, the elastic metallic reinforcers of each protective layer make with the circumferential direction an angle of between 15° and 30°.

Usually, the protective reinforcement comprises two protective layers, formed of elastic metallic reinforcers crossed from one protective layer to the next.

For preference, the inelastic metallic reinforcers of each working layer make with the circumferential direction an angle of between 15° and 40°.

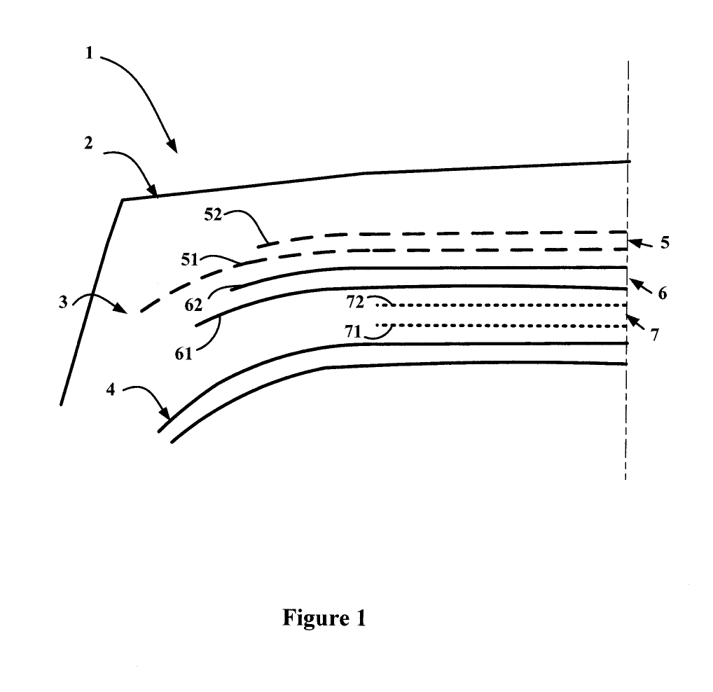

The features of the invention will be better understood with the aid of the description of FIG. 1 which, in a simplified fashion not drawn to scale, depicts a half section, in a meridian plane, of the crown of a tire for a heavy vehicle of the civil engineering type, according to the invention.

FIG. 1 depicts a meridian half section of the crown of a tire 1 for a heavy vehicle of the civil engineering type, comprising: -a tread 2, a crown reinforcement 3 radially on the inside of the tread 2 and a carcass reinforcement 4 radially on the inside of the crown reinforcement 3,
the crown reinforcement 3 comprising, radially from the outside inwards,
a protective reinforcement 5 comprising at least one protective layer (51, 52) formed of elastic metallic reinforcers making with the circumferential direction an angle at least equal to 10°,
a working reinforcement 6 comprising at least two working layers (61, 62) formed of inelastic metallic reinforcers which are crossed from one working layer to the next and make with the circumferential direction an angle of at most 60°,
an additional reinforcement 7 centred on the equatorial plane of the tire, comprising at least one additional layer (71, 72) formed of metallic reinforcers making with the circumferential direction an angle of at most 10°,
the metallic reinforcers of each additional layer (71, 72) being elastic and having a tensile elastic modulus at most equal to 150 GPa.

The invention has been more particularly investigated in the case of a tire of size 40.00R57.

The crown reinforcement of the tire under investigation comprises, radially from the outside inwards:
a protective reinforcement comprising two protective layers, which is formed of elastic metallic reinforcers of type E 4(1+5).26, the structural elongation Aₛ of which is equal to 1.8%, the total elongation at break Aₜ of which is equal to 6% and the tensile elastic modulus of which is equal to 80 GPa, which are crossed from one protective layer to the next and make with the circumferential direction an angle equal to 10° in terms of absolute value,
a working reinforcement comprising two working layers which are formed of inelastic metallic reinforcers of type 189.23 Fr, crossed from one working layer to the next and making with the circumferential direction an angle equal to 33° in terms of absolute value,
an additional reinforcement comprising three additional layers, which is formed of elastic metallic reinforcers of type E 3(1+6).28, the structural elongation Aₛ of which is equal to 1.8%, the total elongation at break Aₜ of which is equal to 7.5% and the tensile elastic modulus of which is equal to 80 GPa, and which make with the circumferential direction a zero angle.

Endurance testing on vehicle demonstrated a significant improvement in terms of the endurance of the crown of a tire according to the invention.

The invention is not restricted to the features described hereinabove and can be extended to other types of metal cord that guarantee the desired additional reinforcement tensile rigidity, such as, for example and nonlimitingly:
corrugated cords,
divided cords.

1. The tire for a heavy vehicle of the civil engineering type, comprising a tread, a crown reinforcement radially on the inside of the tread and a carcass reinforcement radially on the inside of the crown reinforcement, wherein the crown reinforcement comprises comprising, radially from the outside inwards;
a protective reinforcement comprising at least one protective layer formed of elastic metallic reinforcers making with the circumferential direction an angle at least equal to 10°;
a working reinforcement comprising at least two working layers formed of inelastic metallic reinforcers which are crossed from one working layer to the next and make with the circumferential direction an angle of at most 60°; and
an additional reinforcement centred on the equatorial plane of the tire, comprising at least one additional layer formed of metallic reinforcers making with the circumferential direction an angle of at most 10°,
wherein the metallic reinforcers of each said additional layer are elastic and have a tensile elastic modulus at most equal to 150 GPa.

2. The tire for a heavy vehicle of the civil engineering type according to claim 1, wherein the elastic metallic reinforcers of each additional layer have a tensile elastic modulus of between 40 GPa and 150 GPa.

3. The tire for a heavy vehicle of the civil engineering type according to claim 1, wherein the elastic metallic reinforcers of each additional layer are multistrand ropes formed of an assembly of strands made up of individual threads.

4. The tire for a heavy vehicle of the civil engineering type according to claim 1, wherein the elastic metallic reinforcers of each additional layer are multistrand ropes formed of an assembly of strands having two concentric layers of threads, and of structure K * (L+M), where K is the number of strands, L is the number of threads in the internal layer of a strand and M is the number of threads in the external layer of a strand.

5. The tire for a heavy vehicle of the civil engineering type according to claim 1, wherein the elastic metallic reinforcers of each additional layer are cords of formula E 3*(1+6).28, formed of 3 strands, each strand being formed of an internal thread and of an external layer of 6 threads, each thread having a diameter of 0.28 mm.

6. The tire for a heavy vehicle of the civil engineering type according to claim 1, wherein the elastic metallic reinforcers of each additional layer are cords of formula E 4*(4+9).26, formed of 4 strands, each strand being formed of an internal layer of 4 threads and of an external layer of 9 threads, each thread having a diameter of 0.26 mm.

7. The tire for a heavy vehicle of the civil engineering type according to claim 1, wherein the axial width of the additional reinforcement is at most equal to 0.4 times the nominal section width of the tire.

8. The tire for a heavy vehicle of the civil engineering type according to claim 1, wherein the additional reinforcement comprises at least two additional layers.

9. The tire for a heavy vehicle of the civil engineering type according to claim 1, wherein the elastic metallic reinforcers of each additional layer make with the circumferential direction an angle of between 5° and 10°.

10. The tire for a heavy vehicle of the civil engineering type according to claim 1, wherein the elastic metallic reinforcers of each additional layer make with the circumferential direction a zero angle.

11. The tire for a heavy vehicle of the civil engineering type according to claim 1, wherein the elastic metallic reinforcers of each protective layer make with the circumferential direction an angle of between 15° and 30°.

12. The tire for a heavy vehicle of the civil engineering type according to claim 1, wherein the inelastic metallic reinforcers of each working layer make with the circumferential direction an angle of between 15° and 40°.
